(19) United States
(12) Patent Application Publication
(10) Pub. No.: US 2006/0209698 A1
(43) Pub. Date: Sep. 21, 2006

(54) Broadband telecommunication test system and test method used therein

(75) Inventor: Frank Cyriel Michel Defoort, Kruibeke-Bazel (BE)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/366,449

(22) Filed: Mar. 3, 2006

(30) Foreign Application Priority Data
Mar. 4, 2005 (EP) 05290495.0

(51) Int. Cl. H04L 12/26; H04J 1/16

(52) U.S. Cl. 370/241

(57) ABSTRACT

A method for testing the physical layer of a broadband installation at subscriber's house by means of a broadband test device or network analyzer (NA) coupled to the subscriber's house through a broadband connection (BB). The broadband connection is preferably a DSL connection through which the network analyzer performs measurements on the broadband installation. An end-user at the subscriber's house can dialog with the network analyzer through a narrowband responder device, preferably an intelligent voice responder (IVR). The dialog consists of information received from the end-user and translated by the responder device into input control for the network analyzer and of output control from the network analyzer translated by the responder device into instructions towards the end-user. A telecommunication test system and a responder device using this method are also described.

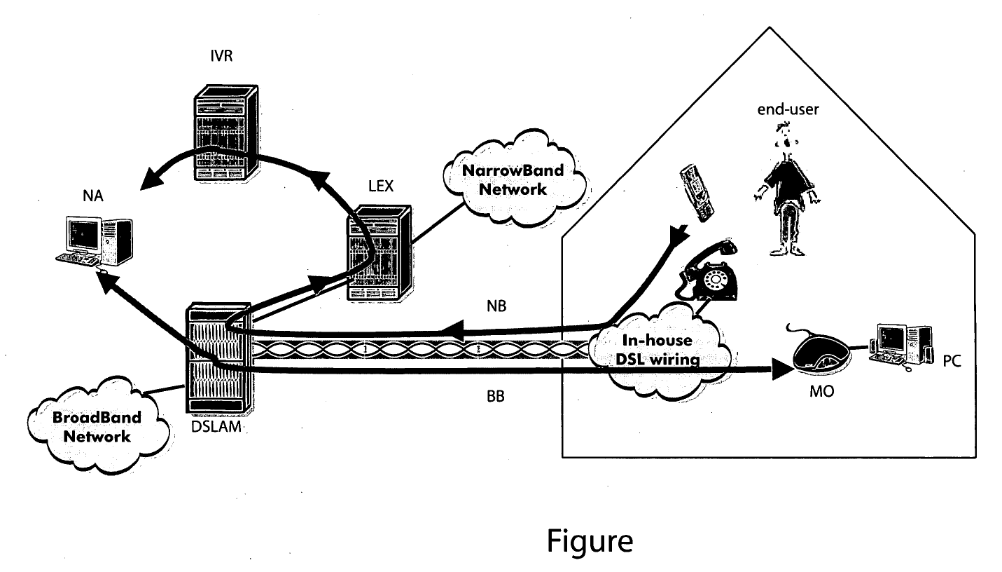

### BACKGROUND OF THE INVENTION

The present invention relates to a method for testing the physical layer of a broadband installation at subscriber's house by means of a broadband test device coupled to said subscriber's house through a broadband connection and so adapted to perform measurements on said broadband installation.

Such a method is already known in the art and can for instance be used in a telecommunication system comprising a broadband test device or Network Analyzer of the type “Alcatel™ 5530” coupled to the subscrilcatel 5530 Network Analyzer is for instance available at the site:
<http://www.alcatel.com/products/productsummary.jhtml?relativePath=/com/en/appxml/opgproduct/alcatel5530networkanalyzertcm228121701635.jhtml>

The known method is used for detecting wiring issues into the houses of the subscribers or end-users from the operator's Central Office [CO]. Examples of such issues are forgotten filters to separate Plain Old Telephone Service [POTS] from Digital Subscriber Line [DSL] signals, badly twisted pair picking up radiated noise, bridged taps, and bad contacts. Actual faults and issues in the physical layer or wiring between the CO and end-user are to certain extend tolerated as long as, for instance, High Speed Internet is running. However, such faults and issues may lead to consequences as lower bitrate than expected, instable lines requiring resynchronization and/or unacceptable error rate on high demanding applications such as video, audio streaming, and gaming running over it. Many of those faults and issues are located inside the houses of the end-users and there is today no push to clean up in-house wiring.

The Network Analyzer used today is an operator-controlled tool able to detect several cabling issues in the houses of the end-users. After detection of in-house cabling problems, it is still up to the operator to take initiative to get the issues resolved, what is on cost of high Operational Expenses [OPEX]. For some operators, this OPEX may become too high, so that they charge end-users to solve an in-house broadband connection wiring problem.

### SUMMARY OF THE INVENTION

An object of the present invention is to provide a method of the above known type but which enables detecting and solving physical wiring faults and issues in the houses of the broadband connection subscribers or end-users at relatively low expenses.

According to the invention, this object is achieved due to the fact that said method comprises the step of allowing an end-user at the subscriber's house to dialog with said broadband test device through a responder device, said dialog comprising information received from said end-user and translated by said responder device into input control for said broadband test device and output control from said broadband test device translated by said responder device into instructions towards said end-user.

In this way, the test service to solve issues, generally belonging to the operator's expertise domain, is now applied remotely and performed with help of the end-user. The end-user exchanges information and instructions with the broadband test device whereby the operator's OPEX is reduced. In other words, means are provided to the end-user to solve himself problems that otherwise the operator needs to solve.

Another characterizing embodiment of the present invention is that said method comprises the step of said broadband test device performing measurements on said broadband installation in accordance with said output control and/or input control translated into instructions and/or from information respectively.

The information and instructions exchanged between the end-user and the broadband network analyzer allows the latter to perform measurements on the broadband installation via the broadband connection and based on these exchanges.

Also another characterizing embodiment of the present invention is that said method comprises the step of establishing the dialog between said end-user and said responder device via a narrowband connection, and that said responder device is a narrowband responder device.

The physical layer of the subscriber's broadband connection is preferably tested by means of using the narrowband connection or channel through which the dialog is established.

Still another characterizing embodiment of the present invention is that said dialog comprises vocal instructions and vocal information.

Preferably, the dialog is transmitted through the narrowband connection since the present testing method may not work well when for instance voice-over-broadband is used. This service could then be interrupted during broadband testing.

Yet another characterizing embodiment of the present invention is that said narrowband responder device is coupled to said narrowband connection via a Local Exchange.

This Local Exchange may further be coupled to a narrowband network.

The present invention has a further embodiment characterized in that said narrowband connection and said broadband connection use the same physical medium.

In this way, the narrowband connection and the broadband connection may share a same medium, but in different frequency spectrum.

In a variant characterizing embodiment of the present invention, said narrowband connection and said broadband connection use a different physical medium

The end-user connects to the broadband and narrowband service not necessarily over a same twisted pair.

In a preferred characterizing embodiment of the present invention, said broadband connection is a Digital Subscriber Line.

A further characterizing embodiment of the present invention is that said narrowband connection is a Plain Old Telephone Service line or a mobile phone connection.

A subscriber having both a broadband Digital Subscriber Line [DSL] and a narrowband connection, e.g. Plain Old Telephone Service [POTS] or mobile [GSM], connects to the broadband and narrowband service such that the end-user can test himself the physical layer of his broadband connection by getting automated guidance over the narrowband connection.

The present invention also relates to a telecommunication test system for testing the physical layer of a broadband installation at subscriber's house, said test system having a broadband test device coupled to said subscriber's house through a broadband connection and so adapted to perform measurements on said broadband installation.

Such a telecommunication test system is generally known in the art and may for instance use the known method mentioned above with the drawback of having the operator to fully control the broadband test device.

A further object of the present invention is to provide a telecommunication test system of the known type but which enables detecting and solving physical wiring faults and issues in the houses of the broadband connection subscribers or end-users at relatively low expenses.

According to the invention, this further object is achieved owing to the fact that said telecommunication test system further comprises a responder device coupled to said broadband test device and adapted to exchange messages with an end-user at the subscriber's house, said responder device being adapted to translate information received from said end-user into input control for said broadband test device, and to translate output control from said broadband test device into instructions towards said end-user.

In this way, output control of the broadband test device is transmitted as instructions to the end-user, whilst information of this end-user is transferred as input control to the broadband test device. The broadband test device can thereby detect several cabling issues in the house of the end-user as will be explained later. In other words, an end-user himself can initiate and control broadband physical layer tests. As a result, the service satisfaction with the end-user is increased, whilst the OPEX of the DSL operators is reduced.

The present invention further also relates to a responder device for the above telecommunication test system according to the invention.

Further characterizing embodiments of the present test system and method to test the physical layer of a subscriber's broadband connection are mentioned in the appended claims.

It is to be noticed that the term ‘comprising’, used in the claims, should not be interpreted as being restricted to the means listed thereafter. Thus, the scope of the expression ‘a device comprising means A and B’ should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

### BRIEF DESCRIPTION OF THE DRAWINGS

The above and other objects and features of the invention will become more apparent and the invention itself will be best understood by referring to the following description of an embodiment taken in conjunction with the accompanying drawings wherein the FIGURE represents a telecommunication test system according to the invention.

### DETAILED DESCRIPTION OF THE INVENTION

The telecommunication test system shown in the FIGURE comprises a broadband test device or network analyzer NA coupled to a subscriber's house via a Digital Subscriber Line Access Multiplexer DSLAM and a broadband connection BB. The broadband connection BB is preferably a Digital Subscriber Line [DSL] associated to a narrowband connection NB also coupling the DSLAM to the subscriber's house. The latter subscriber's house has at least a phone set coupled to the narrowband connection NB as well as an in-house DSL wiring or broadband architecture to which are connected DSL devices such as a modem MO and an a PC. The broadband connection BB is further connected to a BroadBand Network via the DSLAM, whilst the narrowband connection NB is connected to a NarrowBand Network via the DSLAM and a Local EXchange LEX. The telecommunication test system is completed with a narrowband responder device IVR coupled between the local exchange LEX and the network analyzer NA.

The network analyzer NA and the narrowband responder device IVR are located at the operator's side or Central Office [CO] of the telecommunication system. The network analyzer is for instance of the type “Alcatel™ 5530”, whilst the narrowband responder device IVR may be an Intelligent Voice Responder of the type “Alcatel™ 8855 IVR”. The responder device IVR is adapted to establish a dialog between the network analyzer NA and an end-user at the subscriber's house in order to perform tests on the physical layer of the broadband installation at subscriber's house.

To this end, the narrowband responder device IVR exchanges vocal messages with the end-user. IVR translates vocal information received from the end-user into input control for the broadband test device NA and to translates output control from the broadband test device NA into vocal instructions towards the end-user. The end-user can so communicate with the NA through the IVR. The broadband test device or network analyzer NA may for instance guide, via the responder device IVR, the end-user through different tests and may give the end-user advice on how to fix in-house cabling problems.

It is to be noted that, although vocal messages, vocal information and vocal instructions are mentioned above, the present invention applies also to other types of messages, information and/or instructions. In other words, a person skilled in the art may easily extend the exchange over the narrowband connection to any type of interface using for instance websites or emails. These variants will therefore not be described more in detail below.

A typical scenario could be as follows:

the end-user calls the network analyzer NA over the narrowband connection NB and via the responder device IVR;

the network analyzer NA starts tests, preferably broadband tests, over the broadband connection BB;

the network analyzer NA collects test results through the broadband connection BB and provides them to the end-user over the narrowband connection NB and via the responder device IVR; and

the network analyzer NA provides fixing advice to the end-user over the narrowband connection NB and via the responder device IVR.

Control tests issued from the Central Office [CO], i.e. from the network analyzer NA, are for instance:

Single Ended Line Testing [SELT], e.g. reflectometry based; or

Dual Ended Line Testing [DELT] when the line is in showtime.

The broadband test device or network analyzer NA is further preferably adapted to correlate measurements performed on the broadband installation with the output control and/or input control translated towards the end-user by the responder device IVR.

It is to be noted that the narrowband connection NB and the broadband connection BB may either use the same or a different physical medium to transmit their respective data.

It is also to be noted that the narrowband connection NB may either be a Plain Old Telephone Service [POTS] line or a mobile phone connection.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is merely made by way of example and not as a limitation on the scope of the invention, as defined in the appended claims.

1. A method for testing the physical layer of a broadband installation at subscriber's house by means of a broadband test device (NA) coupled to said subscriber's house through a broadband connection (BB) and so adapted to perform measurements on said broadband installation,
characterized in that said method comprises the step of allowing an end-user at the subscriber's house to dialog with said broadband test device (NA) through a responder device (IVR), said dialog comprising information received from said end-user and translated by said responder device into input control for said broadband test device and output control from said broadband test device translated by said responder device into instructions towards said end-user.

2. The method according to claim 1, characterized in that said method comprises the step of said broadband test device (NA) performing measurements on said broadband installation in accordance with said output control and/or input control translated into instructions and/or from information respectively.

3. The method according to claim 1,
characterized in that said method comprises the step of establishing the dialog between said end-user and said responder device (IVR) via a narrowband connection (NB),
and in that said responder device is a narrowband responder device.

4. The method according to claim 3, characterized in that said dialog comprises vocal instructions and vocal information.

5. The method according to claim 3, characterized in that said narrowband responder device is coupled to said narrowband connection (NB) via a Local Exchange (LEX).

6. The method according to claim 3, characterized in that said narrowband connection (NB) and said broadband connection (BB) use the same physical medium.

7. The method according to claim 3, characterized in that said narrowband connection (NB) and said broadband connection (BB) use a different physical medium.

8. The method according to claim 1, characterized in that said broadband connection (BB) is a Digital Subscriber Line (DSL).

9. The method according to claim 3, characterized in that said narrowband connection (NB) is a Plain Old Telephone Service (POTS) line.

10. The method according to claim 3, characterized in that said narrowband connection (NB) is a mobile phone connection.

11. A telecommunication test system for testing the physical layer of a broadband installation at subscriber's house, said test system having a broadband test device (NA) coupled to said subscriber's house through a broadband connection (BB) and so adapted to perform measurements on said broadband installation,
characterized in that said telecommunication test system further comprises a responder device (IVR) coupled to said broadband test device (NA) and adapted to exchange messages with an end-user at the subscriber's house, said responder device being adapted to translate information received from said end-user into input control for said broadband test device, and to translate output control from said broadband test device into instructions towards said end-user.

12. The telecommunication test system according to claim 11, characterized in that said telecommunication test system further comprises a narrowband connection adapted to exchange vocal messages comprising vocal information and vocal instructions.

13. A responder device (IVR) for the telecommunication test system of claim 11,
characterized in that said responder device is a narrowband intelligent voice responder (IVR) adapted to exchange vocal messages with an end-user at the subscriber's house via a narrowband connection (NB).
and in that said responder device is adapted to translate vocal information received from said end-user into input control for said broadband test device, and to translate output control from said broadband test device into vocal instructions towards said end-user.

14. The method according to claim 1, characterized in that said responder device (IVR) is a narrowband intelligent voice responder (IVR) adapted to exchange vocal messages with said end user at the subscriber's house via a narrowband connection (NB), and is adapted to translate vocal information received from said end user into input control for said broadband test device, and to translate output control from said broadband test device into vocal instructions towards said end user.
